(19) United States
(12) Patent Application Publication
(10) Pub. No.: US 2006/0047011 A1
(43) Pub. Date: Mar. 2, 2006

(54) PUR/PIR rigid foams based on aliphatic polyester polyols

(76) Inventors: Jacqueline Kusan-Bindels, Aachen (DE); Uwe Kunzel, Leverkusen (DE); Hartmut Nefzger, Pulheim (DE); Torsten Heinemann, Tarragona (ES)

Correspondence Address: BAYER MATERIAL SCIENCE LLC, 100 BAYER ROAD, PITTSBURGH, PA, 15205, US

(21) Appl. No.: 11/213,031

(22) Filed: Aug. 26, 2005

(30) Foreign Application Priority Data
Sep. 2, 2004 (DE) 102004042525.6

(51) Int. Cl. C08G 18/00

(52) U.S. Cl. 521/155

(57) ABSTRACT

PUR/PIR rigid foams based on aliphatic polyester polyols are produced by reacting an organic polyisocyanate with an isocyanate reactive component that includes a polyester polyol containing units derived from (1) adipic acid and (2) at least one of glutaric, succinic and sebacic acid. These foams may be produced spraying. These foams are particularly suitable for use in laminates.

### BACKGROUND OF THE INVENTION

The present invention relates to PUR/PIR rigid foams based on aliphatic polyester polyols, to a process for producing these PUR/PIR rigid foams by spraying and to laminates containing these PUR/PIR rigid foams.

Nowadays PUR/PIR rigid foams are mainly produced from aromatic polyester polyols, since these have a positive influence on the flame resistance of the PUR/PIR rigid foams and on their thermal conductivity. The raw materials primarily used in the production of aromatic polyester polyols are phthalic acid/phthalic anhydride, terephthalic acid and isophthalic acid. In addition to aromatic polyester polyols, polyether polyols and in some cases also aliphatic polyester polyols are occasionally added to improve the solubility performance of pentanes in the aromatic polyester polyols or to reduce the brittleness of the isocyanurate-containing PUR/PIR rigid foams.

EP-A 1219653 discloses PUR/PIR rigid foams with improved flame resistance and reduced thermal conductivity based on aromatic polyester polyols. In addition, the use of aliphatic, cycloaliphatic or heterocyclic polyester polyols is also proposed.

WO 97/48747 teaches that PUR/PIR rigid foams with reduced brittleness and improved surface adhesion can be produced if the polyol component contains both aromatic and aliphatic polyester polyols.

WO-A2 2004/060950 discloses PUR/PIR rigid foams for spray foaming applications with improved flame resistance and improved lambda ageing behavior based on aromatic polyester polyols. In addition, the use of aliphatic or heterocyclic polyester polyols is proposed.

WO-A2 2004/060950 teaches that PUR/PIR rigid foams with high thermal resistance and improved flame resistance can be produced if the polyol component contains high-functionality aromatic polyester polyols.

U.S. Pat. No. 6,495,722 and U.S.-A1 2002/0040122 describe the production of pure water-blown systems using polyols based on Mannich bases and teach that only use of such polyols makes high flame resistance and dimensional stability obtainable. A major disadvantage of such polyols based on Mannich bases is their high viscosity and their corresponding processability as spray foam systems. Due to their high viscosity, mixing problems occur and therefore foams with poor mechanophysical properties are obtained.

### SUMMARY OF THE INVENTION

It has now been found that if certain aliphatic polyester polyols are used, PUR/PIR rigid foams can be produced with improved flame resistance, low thermal conductivity, reduced brittleness and improved surface adhesion and surface quality. Additionally, low viscosities can be adjusted for use in the spraying process and rigid foams with very high dimensional stability can be produced, even without the addition of aromatic polyester polyols. This is all the more surprising since until now it was assumed that the use of aromatic polyester polyols was indispensable in order to obtain high flame resistance.

### DETAILED DESCRIPTION OF THE INVENTION

The present invention is directed to PUR/PIR rigid foams and to a process for their production produced by reacting an organic polyisocyanate component with a component containing compounds having isocyanate group-reactive hydrogen atoms, at an index (the molar ratio of the isocyanate groups to the isocyanate group-reactive hydrogen atoms multiplied by 100) of 100 to 400, preferably 180 to 400, in the presence of suitable auxiliary substances and additives as well as blowing agents and co-blowing agents. The isocyanate-reactive component contains at least one aliphatic polyester polyol which in addition to units derived from adipic acid also contains units derived from glutaric acid, succinic acid or sebacic acid. The rigid foams produced by this process are e.g. particularly useful for the production of laminates.

Mixtures of isomers of diphenyl methane diisocyanate (MDI) and oligomers thereof are useful as the organic polyisocyanate component for the production of PUR/PIR rigid foams. Such mixtures are generally known as “polymeric MDI” (pMDI). Also suitable for use as the polyisocyanate component are NCO prepolymers produced by the reaction of polymeric MDI with aliphatic or aromatic polyether polyols or polyester polyols (e.g., polyether polyols or polyester polyols having 1 to 4 hydroxyl groups and a number-average molecular weight of from 60 to 4000).

The isocyanate-reactive component contains at least one aliphatic polyester polyol, which in addition to units derived from adipic acid also contains units derived from glutaric acid, succinic acid and/or sebacic acid, preferably glutaric acid and/or succinic acid. It is also preferable for the aliphatic polyester polyol to contain no aromatic units. A particularly preferred aliphatic polyester polyol can be obtained by reacting a mixture containing from 15 to 45 wt. % of adipic acid, from 40 to 55 wt. % of glutaric acid and from 10 to 35 wt. % of succinic acid, with the total wt. % being equal to 100 wt. %. The succinic acid and the glutaric acid can be present in part as anhydride.

Glycols such as ethylene glycol, diethylene glycol, triethylene glycol, tetraethylene glycol, 1,2-propanediol, 1,3-propanediol, 1,4-butanediol, 3-methyl-1,5-pentanediol, 1,5-pentanediol, 1,6-hexanediol, 1,10-decanediol, glycerol, trimethylol propane, or mixtures thereof, are used as the alcohol component for the production of aliphatic polyester polyols. Monoethylene glycol and diethylene glycol are preferably used, most preferably, monoethylene glycol.

The aliphatic polyester polyols preferably exhibit a functionality of from 1.8 to 6.5, preferably from 1.8 to 3.0, an OH value of from 15 to 500 mg KOH/g, preferably from 100 to 300, and an acid value of from 0.5 to 5.0 mg KOH/g.

In addition to the aliphatic polyester polyols, the isocyanate-reactive component can also include other compounds having isocyanate group-reactive hydrogen atoms which are not polyester polyols, such as polyether polyols or low-molecular-weight chain extenders or crosslinking agents. These additives can bring about an improvement in the flowability of the reaction mixture and in the emulsifying ability of the blowing agent-containing formulation. These additives can also bring about the above-mentioned properties on continuous production lines for laminates having flexible or rigid topcoats. Preferred additive compounds for the production of laminates include those exhibiting a functionality of from 1.8 to 4.5, an OH value of from 20 to 460 mg KOH/g. Additive compounds having an OH value of from 20 to 800 mg KOH/g and optionally, primary OH groups, are preferred for spray applications. Particularly referred polyether polyols exhibit a functionality of from 2.0 to 3.0 (for the production of laminates) and from 2.0 to 4.5 (for spray processes), an OH value of from 20 to 56 (for the production of laminates) and of from 400 to 800 (for spray processes), and a primary OH group content of more than 80 mol %, in particular more than 90 mol % (for the production of laminates) and a secondary OH group content of more than 90 mol % for spray processes.

A preferred isocyanate-reactive component for the production of laminates includes: (1) from 65 to 100 wt. %, preferably from 80 to 100 wt. %, of aliphatic polyester polyol; (2) from 0 to 25 wt. %, preferably from 5 to 15 wt. %, of polyether polyol having a functionality of from 2.0 to 4.5 and an OH value of from 20 to 460, preferably from 20 to 56; and (3) from 0 to 10 wt. %, preferably from 0 to 5 wt. %, of one or more low-molecular-weight chain extenders or crosslinking agents having a functionality of from 3.0 to 4.0 and an OH value of from 900 to 2000. The values in wt. % relate in each case to the total amount of compounds having isocyanate group-reactive hydrogen atoms in the isocyanate-reactive component.

A preferred polyol component for spray processes includes: (1) from 5 to 100 wt. %, preferably from 10 to 70 wt. %, of an aliphatic polyester polyol; and (2) from 0 to 95 wt. %, preferably from 30 to 90 wt. %, of a polyether polyol having a functionality of from 2.0 to 4.5 and an OH number of 20 to 800, preferably from 400 to 800 mg KOH/g. The values in wt. % relate in each case to the total quantity of compounds with isocyanate group-reactive hydrogen atoms in the isocyanate-reactive component.

Flame retardants are generally added to the isocyanate reactive component preferably in an amount of from 10 to 25 wt. % (for laminates) and from 5 to 50 wt. % (for spray processes), relative to the total amount of compounds having isocyanate group-reactive hydrogen atoms in the isocyanate reactive component. Such flame retardants are known to those skilled in the art and are described for example in “Kunststoffhandbuch”, Volume 7 “Polyurethane”, chapter 6.1. They can, for example, be bromine-containing and/or chlorine-containing polyols or phosphorus compounds such as the esters of ortho-phosphoric acid and meta-phosphoric acid, which can also include halogen. Flame retardants which are liquid at room temperature are preferably chosen.

Blowing agents and co-blowing agents are used in a sufficient amount to obtain a dimensionally stable foam matrix and the desired density. For laminates, this is generally between 0 and 6.0 wt. % of co-blowing agent and between 1.0 and 30.0 wt. % of blowing agent, relative in each case to 100 wt. % of the isocyanate reactive component. The ratio of co-blowing agent to blowing agent can be from 1:7 to 1:35 depending on requirements. For spray processes, between 1.0 and 15.0 wt. % of blowing agent and between 1.5 and 4.0 wt. % of co-blowing agent, relative in each case to 100 wt. % of isocyanate reactive component are generally used. Depending on the requirements, the quantitative ratio between blowing agent and co-blowing agent can be between 20:1 and 0:100.

Hydrocarbons, e.g., the isomers of pentane, or fluorinated hydrocarbons, e.g., HFC 245fa (1,1,1,3,3-pentafluoropropane), HFC 365mfc (1,1,1,3,3-pentafluoro-butane) or mixtures thereof with HFC 227ea (heptafluoropropane), may be used as blowing agents. Different classes of blowing agent can also be combined. Thus thermal conductivities, measured at 10° C., of less than 20 mW/mK can be obtained with mixtures of n- or cyclo-pentane with HFC 245fa in the ratio 75:25 (n-/cyclo-pentane:HFC 245fa), for example.

Water is generally used as the co-blowing agent, preferably in an amount of up to 6 wt. %, more preferably from 0.5 to 4 wt. % for laminates and in quantities of up to 5 wt. %, and more preferably from 1.5 to 4 wt. % for spray processes, relative to the total amount of compounds having isocyanate group-reactive hydrogen atoms in the isocyanate reactive component. The use of conventional blowing agents can be dispensed with completely for spray processes and the cell gas can be generated solely by the co-blowing agent.

Catalysts conventionally used in polyurethane chemistry are generally added to the isocyanate reactive component. The amine-type catalysts needed to produce a PUR/PIR rigid foam and the salts used as trimerization catalysts are used in an amount such that elements having flexible topcoats can be produced, for example on continuous production lines, at speeds of up to 60 m/min, depending on the thickness of the element and insulating foams on pipes, walls, roofs and tanks and in refrigerators can be produced with adequate curing times in a spray foaming process.

Examples of such catalysts are: triethylene diamine, N,N-dimethylcyclo-hexylamine, tetramethylene diamine, 1-methyl-4-dimethylaminoethyl piperazine, triethylamine, tributylamine, dimethyl benzylamine, N,N′,N″-tris-(dimethyl-aminopropyl) hexahydrotriazine, dimethylaminopropyl formamide, N,N,N′,N′-tetramethylethylene diamine, N,N,N′,N′-tetramethyl butane diamine, tetramethyl hexane diamine, pentamethyl diethylene triamine, tetramethyl diaminoethyl ether, dimethyl piperazine, 1,2-dimethyl imidazole, 1-azabicyclo[3.3.0]octane, bis-(dimethyl aminopropyl) urea, N-methyl morpholine, N-ethyl morpholine, N-cyclohexyl morpholine, 2,3-dimethyl-3,4,5,6-tetrahydropyrimidine, triethanolamine, diethanolamine, triisopropanolamine, N-methyl diethanolamine, N-ethyl diethanolamine, dimethyl ethanolamine, tin (II) acetate, tin (II) octoate, tin (II) ethyl hexoate, tin (II) laurate, dibutyl tin diacetate, dibutyl tin dilaurate, dibutyl tin maleate, dioctyl tin diacetate, tris-(N,N-dimethyl aminopropyl)-s-hexahydrotriazine, tetramethyl ammonium hydroxide, sodium acetate, sodium octoate, potassium acetate, potassium octoate, sodium hydroxide or mixtures of these catalysts.

Suitable examples of foam surfactants, which are likewise added to the isocyanate reactive component, are primarily polyether siloxanes. These compounds are generally structured in such a way that a copolymer of ethylene oxide and propylene oxide is bonded to a polydimethyl siloxane backbone.

Solid additives such as nanoparticles, for example, can be added to the isocyanate reactive component to influence the lambda ageing performance. Other examples of solid additives which can optionally be incorporated in the formulation according to the invention are known from the literature.

The PUR/PIR rigid foams of the present invention are generally produced by the single-stage process known to the person skilled in the art, in which the reaction components are reacted with one another continuously or batchwise either manually or with the aid of mechanical devices in a high-pressure or low-pressure process after being metered onto a conveyor belt or into or on suitable molds. Examples of such processes are described in U.S. Pat. No. 2,764,565, in G. Oertel (Ed.) “Kunststoff-Handbuch”, Volume VII, Carl Hanser Verlag, 3^{rd} edition, Munich 1993, p. 267 ff., and in K. Uhlig (Ed.) “Polyurethan Taschenbuch”, Carl Hanser Verlag, 2^{nd} edition, Vienna 2001, p. 83-102.

The PUR/PIR rigid foams of the present invention can be used in many different ways as an insulating material. Examples from the construction industry include wall insulation materials, pipe shells and pipe half shells, roof insulation materials, wall elements and flooring panels.

The invention also provides laminates containing the PUR/PIR rigid foams according to the invention. These have a core made from PUR/PIR rigid foam according to the invention to which topsheets are permanently bonded. The topsheets can be flexible or rigid. Examples are paper topsheets, nonwoven topsheets (e.g. mineral or glass fibre), metal topsheets (e.g. steel, aluminium), wooden topsheets and composite topsheets. The production of such laminates is known in principle to the person skilled in the art and is described for example in G. Oertel (Ed.) “Kunststoff-Handbuch”, Volume VII, Carl Hanser Verlag, 3^{rd} edition, Munich 1993, p. 272-277. The double conveyor process is preferably used to produce laminates according to the invention without difficulty at conveyor speeds of up to 60 m/min.

A particular advantage of the laminates of the present invention is the improved adhesion of the topsheets. In the case of laminates produced using aromatic polyester polyols, a minimum of adhesion between foam and topsheets is observed after approximately 15 minutes. This effect does not occur with the laminates according to the invention in double conveyor processes. Once the laminates leave the line, the topsheets remain permanently bonded to the foam, so the laminates according to the invention can be sent directly for unstacking and/or for further processing without difficulty, even in cold winter months.

A further special advantage of the spray foams of the present invention is their improved fire-resistant properties compared with systems based on aromatic polyester polyols and their improved dimensional stability in purely CO₂-blown foams having core densities of from 22 to 40 kg/m3. In addition, the low viscosity of the present mixture based on the aliphatic polyester polyol and its pure component is particularly advantageous.

Having thus described the invention, the following Examples are given as being illustrative thereof.

### EXAMPLES

### Examples 1-5

Polyol Component 1 (Comparison):

A formulation was produced from the following components:
95 wt. % of an aromatic polyester polyol having an OH value of 210 mg KOH/g and a viscosity of 8000 mPas at 25° C. (commercially available under the name Desmophen® 23HS81 from Bayer MaterialScience AG, and
5 wt. % triethanolamine.
   Polyol Component 2 (Comparison):
100 wt. % of an aromatic polyester polyol having an OH value of 235 mg KOH/g and a viscosity of 3600 mPas at 25° C. (commercially available under the name Terate® 2541 from KoSa GmbH & Co. KG, D-65795 Hattersheim am Main).
   Polyol Component 3 (According to the Invention):

A formulation was produced from the following components:
95 wt. % of an aliphatic polyester polyol having an OH value of 214 mg KOH/g and a viscosity of 2000 mPas at 25° C., produced by reacting a mixture of adipic acid, succinic acid and glutaric acid with ethylene glycol,
5 wt. % triethanolamine.
   Polyol Component 4 (According to the Invention):

A formulation was produced from the following components:
86 wt. % of an aliphatic polyester polyol having an OH value of 214 mg KOH/g and a viscosity of 2000 mPas at 25° C., produced by reacting a mixture of adipic acid, succinic acid and glutaric acid with ethylene glycol, and
14 wt. % of an aliphatic polyether having an OH value of 28, 90 mol % of primary OH groups and a viscosity of 860 mPas at 25° C. (commercially available under the name Desmophen® L 2830 from Bayer MaterialScience AG).
   Polyol Component 5 (According to the Invention):

A formulation was produced from the following components:
86 wt. % of an aliphatic polyester polyol having an OH value of 214 mg KOH/g and a viscosity of 2000 mPas at 25° C., produced by reacting a mixture of adipic acid, succinic acid and glutaric acid with ethylene glycol, and
14 wt. % of an aromatic polyether having an OH value of 460 and a viscosity of 8000 mPas at 25° C. (commercially available under the name Desmophen® VP.PU 1907 from Bayer MaterialScience AG).

PUR/PIR rigid foams were produced in the laboratory on the basis of the polyol components. To this end, flame retardants, a polyether siloxane-based foam surfactant, catalysts, water and n-pentane as blowing agent were added to the relevant isocyanate reactive component, and the mixture thus obtained was mixed with polyisocyanate (a mixture of MDI isomers and their higher homologues with an NCO content of 31 wt. % (commercially available under the name Desmodur® 44V40L from Bayer MaterialScience AG) and the mixture was poured into a paper mold (30×30×10 cm³) and reacted therein. The exact formulations for the individual experiments are reproduced in Table 1 along with the results of the physical measurements on the samples obtained.

The adhesion was tested manually on paper topsheets at specific time intervals on fresh isocyanurate-containing PUR/PIR rigid foam produced according to the invention. The results were graded qualitatively. A rating of “good” means that the paper can be peeled off only with difficulty. A “satisfactory” rating means that the paper can be peeled off with a little effort. An “adequate” rating means that the paper can be peeled off easily. A “defective” rating means that the paper only adhered to the foam in parts. An “unsatisfactory” rating means that the paper exhibits no adhesion to the foam. The brittleness was determined qualitatively by pressing thumbs into the foams in the core and edge area. The density was calculated on a 10×10×10 cm³ cube by determining the weight. The lambda values were determined using the heat flow method in accordance with DIN 52616 at a central temperature of 10° C. (Fox device). The fire performance was determined in accordance with DIN 4102.

TABLE 1

| | Example | | | | |
|---|---|---|---|---|---|
| | 1* | 2* | 3 | 4 | 5 |
| Polyol Component 1 [pbw] | 100 | | | | |
| Polyol Component 2 [pbw] | | 100 | | | |
| Polyol Component 3 [pbw] | | | 100 | | |
| Polyol Component 4 [pbw] | | | | 100 | |
| Polyol Component 5 [pbw] | | | | | 100 |
| TCPP [pbw] | 18.0 | 18.0 | 18.0 | 18.0 | 18.0 |
| Surfactant [pbw] | 2.0 | 2.0 | 2.0 | 2.0 | 2.0 |
| DMCHA [pbw] | 1.0 | 1.2 | 1.0 | 0.8 | 0.8 |
| K acetate in DEG [pbw] | 4.6 | 4.8 | 3.6 | 3.0 | 3.0 |
| Water [pbw] | 1.7 | 2.3 | 1.3 | 1.7 | 1.8 |
| n-Pentane [pbw] | 17.1 | 17.9 | 16.9 | 15.3 | 16.8 |
| Isocyanate [pbw] | 245 | 306 | 240 | 235 | 235 |
| Index | 255 | 298 | 273 | 300 | 278 |
| Bulge in center [mm] | 106 | 107 | 102 | 101 | 102 |
| Brittleness | high | high | None | none | none |
| Adhesion after 5 min | defective | adequate | Good | good | good |
| Adhesion after 15 min | unsatisfactory | unsatisfactory | Good | good | good |
| Adhesion after 24 h | good | good | Good | good | good |
| Core density [kg/m³] | 32.2 | 33.1 | 33.5 | 30.6 | 30.0 |
| Lambda at 10° C. [mW/mK] | 22.0 | 22.7 | 22.5 | 21.9 | 22.2 |
| Flame height [mm] | 130 | 135 | 115 | 118 | 120 |
| Fire class | B2 | B2 | B2 | B2 | B2 |

*Comparative Example
pbw = parts by weight

TCPP: Tris(β-chloroisopropyl)phosphate
DMCHA: Dimethyl cyclohexylamine
DEG: Diethylene glycol

It is clear from the results in Table 1 that both the brittleness and the minimum adhesion can be improved. Surprisingly it was established that the bulge in the 10 cm thick foam can be greatly minimized by the use of aliphatic polyester polyols. Furthermore, an improved fire performance was even observed using the purely aliphatic polyester polyol according to the invention, which had not been expected.

### Examples 6-7

Polyol Component 6 (Comparison)

A formulation was prepared from the following components:
47 wt. % of an aromatic polyether polyol with an OH number of 460 mg KOH/g and a viscosity of 8,000 mPas at 25° C. (commercially available under the name Desmophen® 1907 from Bayer MaterialScience AG),
16 wt. % of an aromatic polyester polyol with an OH number of 240 and a viscosity of 12,500 mPas at 75° C. (Polyester S240P, Bayer MaterialScience),
3 wt. % water,
30 wt. % trischloroisopropyl phosphate (commercially available under the name Levagard PP® from Lanxess AG),
0.3 wt. % dibutyl tin dilaurate (Air Products),
   0.5 wt. % pentamethyldiethylene triamine (Air Products),
   2.2 wt. % dimethylcyclohexylamine (Rheinchemie),
   1 wt. % surfactant (commercially available under the name Tegostab® B8450 from Goldschmidt AG)
      Polyol Component 7 (According to the Invention):

A formulation was produced from the following components:
47 wt. % of an aromatic polyether polyol with an OH number of 460 mg KOH/g and a viscosity of 8,000 mPas at 25° C. (commercially available under the name Desmophen® 1907 from Bayer MaterialScience AG),
16 wt. % of an aliphatic polyester polyol with an OH number of 214 mg KOH/g and a viscosity of 2,000 mPas at 25° C., produced by reacting a mixture of adipic acid, succinic acid and glutaric acid with ethylene glycol,
3 wt. % water,
30 wt. % trischloroisopropyl phosphate (commercially available under the name Levagard PPθ from Lanxess AG),
0.3 wt. % dibutyl tin dilaurate (Air Products),
0.5 wt. % pentamethyldiethylene triamine (Air Products),
2.2 wt. % dimethylcyclohexylamine (Rheinchemie),
1 wt. % surfactant (commercially available under the name Tegostab® B8450 from Goldschmidt AG)

Foams were produced from each of Polyol Components 6 and 7 in the manner described below in Examples 8-11. The relative amounts of polyol component and isocyanate component and the properties of the resultant foams are reported in Table 2.

TABLE 2

Example

| | 6* | 7 |
|---|---|---|
| Polyol Component 6 [pbw] | 50 | |
| Polyol Component 7 [pbw] | | 50 |
| Isocyanate [pbw] | 50 | 50 |
| Index | 125 | 125 |
| Stirring time [s] | 2 | 2 |
| Creaming time [s] | 2 | 1.8 |
| Setting time [s] | 7.5 | 7.1 |
| Free-rise density [kg/m³] | 40.4 | 39.9 |
| Fire properties according | The Euroclass E | Euroclass E |
| to EN ISO 11925-2 | requirement was | |
| | not satisfied. | |

*Comparative Example
pbw—parts by weight

### Examples 8-11

Polyol Component 8 (Comparison):

A formulation was produced from the following components:
13.1 wt. % of a Mannich base based on nonylphenol with an OH number of 740 mg KOHIg and a viscosity 12,000 mPas at 25° C. (commercially available under the name of Desmophen® 5118-2 from Bayer MaterialScience AG),
52.3 wt. % of an aromatic polyester polyol with an OH number of 240 and a viscosity of 12,500 mPas at 75° C. (Polyester S240P, Bayer MaterialScience),
2.8 wt. % water,
17.7 wt. % trischloroisopropyl phosphate (commercially available under the name Levagard PP® from Lanxess AG),
0.3 wt. % dibutyl tin dilaurate (Air Products),
0.6 wt. % pentamethyldiethylene triamine (Air Products),
2.2 wt. % dimethylcyclohexylamine (Rheinchemie),
1 wt. % surfactant (commercially available under the designation L 6900 from GE-OSi)
   Polyol Component 9 (According to the Invention):

A formulation was produced from the following components:
13.1 wt. % of a Mannich base based on nonylphenol with an OH number of 740 mg OH/g and a viscosity of 12,000 mPas at 25° C. (commercially available under the name Desmophen® 5118-2 from Bayer MaterialScience AG),
52.3 wt. % of an aliphatic polyester polyol with an OH number of 214 mg KOH/g and a viscosity of 2,000 mPas at 25° C., produced by reacting a mixture of adipic acid, succinic acid and glutaric acid with ethylene glycol,
2.8 wt. % of water,
17.7 wt. % of trischloroisopropyl phosphate (commercially available under the name Levagard PP® from Lanxess AG),
0.3 wt. % dibutyl tin dilaurate (Air Products),
0.6 wt. % pentamethyldiethylene triamine (Air Products),
2.2 wt. % dimethylcyclohexylamine (Rheinchemie),
1 wt. % surfactant (commercially available under the designation L 6900 from GE-OSi)
   Polyol Component 10 (Comparison):

A formulation was produced from the following components:
13.1 wt. % of a Mannich base based on nonylphenol with an OH number of 740 mg KOHI/g and a viscosity of 12,000 mPas at 25° C. (commercially available under the name Desmophen® 5118-2 from Bayer MaterialScience AG),
52.3 wt. % of an aromatic polyester polyol with an OH number of 240 and a viscosity of 12,500 mPas at 75° C. (Polyester S240P, Bayer MaterialScience),
2.8 wt. % water,
17.7 wt. % trischloroisopropyl phosphate (commercially available under the name Levagard PP® from Lanxess AG),
0.3 wt. % dibutyl tin dilaurate (Air Products),
0.6 wt. % pentamethyldiethylene triamine (Air Products),
2.2 wt. % dimethylcyclohexylamine (Rheinchemie),
1 wt. % surfactant (commercially available under the designation L 6900 from GE-OSi)
   Polyol Component 11 (According to the Invention):

A formulation was produced from the following components:
13.1 wt. % of a Mannich base based on nonylphenol with an OH number of 740 mg KOH/g and a viscosity of 12,000 mPas at 25° C. (commercially available under the name Desmophen® 5118-2 from Bayer MaterialScience AG),
52.3 wt. % of an aliphatic polyester polyol with an OH number of 214 mg KOH/g and a viscosity of 2,000 mPas at 25° C., produced by reacting a mixture of adipic acid, succinic acid and glutaric acid with ethylene glycol,
2.8 wt. % water,
17.7 wt. % trischloroisopropyl phosphate (commercially available under the name Levagard PP® from Lanxess AG),
0.3 wt. % dibutyl tin dilaurate (Air Products),
0.6 wt. % pentamethyldiethylene triamine (Air Products),
2.2 wt. % dimethylcyclohexylamine (Rheinchemie),
1 wt. % surfactant (commercially available under the designation L 6900 from GE-OSi)

Foams were produced from each of Polyol Components 8-11 in the manner described below. The relative amounts of polyol and isocyanate components and the physical properties of the product foams are reported in Table 3.

TABLE 3

| | Example | | | |
|---|---|---|---|---|
| | 8* | 9 | 10* | 11 |
| Polyol Component 8 | 45 | | | |
| [pbw] | | | | |
| Polyol Component 9 | | 45 | | |
| [pbw] | | | | |
| Polyol Component 10 | | | 45 | |
| [pbw] | | | | |
| Polyol Component 11 | | | | 45 |
| [pbw] | | | | |
| R 245fa [pbw] | 5 | 5 | | |
| R 365mfc/227ea [pbw] | | | 5 | 5 |
| Isocyanate [pbw] | 50 | 50 | 50 | 50 |
| Index | 105-110 | 105-110 | 105-110 | 105-110 |
| Stirring time [s] | 2 | 2 | 2 | 2 |
| Creaming time [s] | 2 | 2 | 2.1 | 2.2 |
| Setting time [s] | 5.9 | 5.7 | 5.8 | 5.7 |
| Free-rise density | 30.9 | 31.0 | 31.9 | 31.7 |
| [kg/m³] | | | | |
| Viscosity of the | 780 | 276 | 760 | 279 |
| formulation [mPas] | | | | |
| at 25° C. | | | | |

*Comparative Example
pbw = parts by weight

Based on the formulations, PUR/PIR rigid foams were produced in the laboratory from each of Polyol Components 6-11. For this purpose the respective formulations were mixed with polyisocyanate (a mixture of MDI isomers and their higher homologues with an NCO content of 30.5 wt. %, commercially available under the name Desmodur® 44V20L from Bayer Material Science AG) and the mixture was poured into a paper mold (30×30×10 cm³) and reacted completely therein. The precise recipes of the individual tests are shown in each of Tables 2 and 3 as well as the results of the physical measurements carried out on the resulting samples.

The core density was calculated on a 10×10×10 cm³ cube by determining the weight. The fire properties were determined according to EN ISO 11925-2. The viscosity was determined by means of a Viscolab LC 1 rotary viscometer.

From the results in Table 2 it becomes clear that improved fire properties are observed when using the purely aliphatic polyester polyol according to the invention, which was not to be expected.

From the results in Table 3 it becomes clear that HFC-blown spray foams having a low core density and high reactivity can be obtained when using the aliphatic polyester polyol according to the invention. The low viscosity of the formulation allows it to be processed in commercially available pneumatic high-pressure spraying units, which is not possible when using a highly viscous formulation containing an aromatic polyester polyol.

Although the invention has been described in detail in the foregoing for the purpose of illustration, it is to be understood that such detail is solely for that purpose and that variations can be made therein by those skilled in the art without departing from the spirit and scope of the invention, except as it may be limited by the claims.

What is claimed:

1. A PUR/PIR rigid foam which is the reaction product of
a) an organic polyisocyanate component with
b) an isocyanate reactive component comprising at least one aliphatic polyester polyol which contains units derived from (1) adipic acid
and (2) at least one of glutaric, succinic and sebacic acid at an index of from 100 to 400.

2. The foam of claim 1 in which the polyisocyanate and isocyanate-reactive components are reacted at an index of from 180 to 400.

3. A process for the production of PUR/PIR rigid foams comprising spraying a reaction mixture comprising
a) an organic polyisocyanate component and
b) an isocyanate reactive component comprising at least one aliphatic polyester polyol which contains units derived from (1) adipic acid and (2) at least one of glutaric acid, succinic acid and sebacic acid
at an index of from 100 to 400.

4. A laminate produced from the foam of claim 1.
